(19) United States
(12) Patent Application Publication
(10) Pub. No.: US 2022/0073160 A1
(43) Pub. Date: Mar. 10, 2022

(54) Bicycle Anti-theft Apparatus and System Combined With Bottle Holder

(71) Applicants: James Eric Dotter, Boulder, CO (US); Steven Maxey, Thornton, CO (US); Neil Blank, Eldorado Springs, CO (US)

(72) Inventors: James Eric Dotter, Boulder, CO (US); Steven Maxey, Thornton, CO (US); Neil Blank, Eldorado Springs, CO (US)

(73) Assignee: MaxTracker LLC, Thornton, CO (US)

(21) Appl. No.: 17/465,621

(22) Filed: Sep. 2, 2021

Related U.S. Application Data
(60) Provisional application No. 63/075,000, filed on Sep. 4, 2020.

(51) Int. Cl. B62H 5/00; G06K 9/00; H04W 76/10; B62J 11/04; G01S 19/01

(52) U.S. Cl. CPC B62H 5/00; G06K 9/00013; H04W 4/021; B62J 11/04; G01S 19/01; H04W 76/10

(57) ABSTRACT

An apparatus that attaches to a bicycle, that is capable of detecting signs of an attempted theft, and of reporting this to users via their mobile phone, to aid in catching or chasing away a thief before they can steal the bicycle. The device is also capable of reporting its location in real time to the owner in a similar manner, to aid in catching the thief and recovering the bicycle. The device also incorporates the function of a “bottle cage” for holding a bottle of liquid to refresh the rider.

### Background

Bicycle riding is increasingly popular as a means of basic transport, as exercise, and as a pleasurable outdoor activity. Bicycles have increased in engineering sophistication over the years, and some are now quite expensive. As expensive yet highly mobile and light weight objects that are often left unattended, bicycles are easy prey to theft.

Bicycles are easy to steal and difficult to recover. They can be transported out of the area in minutes, even serving as the thief's get-away vehicle, and are easily hidden out of sight. The number of bicycle thefts each year is staggering, and the odds of recovering a stolen bicycle are dismal.

Automobile thefts have been greatly reduced using GPS tracking technologies. While the same basic techniques can apply to bicycles, the specific needs of bicycle owners require a unique solution. For example, an automobile has many places to attach or store an anti-theft device, but a typical bicycle has few options for that.

Bicycle frames are customarily built with a pair of threaded nuts placed 2.5 inches (64 mm) apart. These are built into the frame at one or several locations and are called “bosses.” Typical locations are the down-tube or the seat-tube, convenient for the rider to reach down and grab a bottle while riding. These customary bosses, herein referred to as Bottle Cage Bosses, have become standardized. A bottle holder, customarily known as a “bottle cage” (herein: Bottle Cage) attaches to the bike via two Bottle Cage Screws that screw into the two Bottle Cage Bosses, This is the customary way in which a rider can store a bottle of a refreshing beverage. The rider can get a drink without having to stop and get off the bike.

FIG. 2 shows the typical placement and spacing of these customary Bottle Cage Bosses 3 as built into the frame of a bicycle 22. FIG. 2 also shows the location of the two Bottle Cage Screws 28, holding the Bottle Cage 21 (the Bottle Cage Screws are obscured from view in FIG. 2). FIG. 2 does not depict the present invention, but rather the standardized method of providing for carrying liquids while riding. Bottle Cage Screws, and the corresponding built-in-frame Bottle Cage Bosses to accept them, are standardized to 5 mm machine screws with a thread pitch of 80 (meaning 0.8 mm between threads). Lengths of the screws vary, usually between 15 mm and 20 mm in length.

It is customary for cyclists to have a specialized bottle for holding liquid during a ride. Globally, the cycling term for this specialized bottle is a “bidon” (pronounced BEAD-OWN). It is referred to herein as a Cycling Bottle or simply a Bottle. This Bottle is specifically designed to be held in place on the bicycle by a Bottle Cage. It has a set of features specific to this task. First, it is customarily a straight sided cylindrical shape to enable it to slide into and out of the Bottle Cage when the rider so desires. Second, it features a deviation from the cylindrical shape, a narrowing of the bottle diameter near the top, in order to be held in place by a special Bottle Retention Hook on the Bottle Cage. This narrowing is herein referred to as the Neck of the bottle.

Bottle Cages are also specific to cycling, and they have a set of features specific to their task, corresponding to the features of the Cycling Bottle. A customary Bottle Cage has a shape that lends itself to holding a cylindrical Cycling Bottle, and a protrusion that fits into the Neck of a Cycling Bottle. FIG. 2 shows a typical Bottle and Cage arrangement: shown is a customary cylindrical Cycling Bottle 5 and the customary position thereon of the Neck 7, a customary Bottle Cage 21 mounted on a bicycle 22, with a Bottle Retention Hook 6 aiding in holding the Cycling Bottle 5 in place, by fitting into the area of the Neck 7. FIG. 2 does not depict the present invention, but rather a customary, standardized arrangement.

### BRIEF DESCRIPTION OF THE FIGURES

FIG. 1A, shows an exploded view of one exemplary implementation in which a Mounting Bracket 2 is attached to a standard bicycle 22 by means of the standard Bottle Cage Bosses 3. FIG. 1B shows a cross section of FIG. 1A, and FIG. 1C shows the exploded view of 1A, once assembled.

FIG. 2 shows the typical Bottle Cage 21 mounted on a typical bicycle 22, and the customary placement and spacing of Bottle Cage Bosses 3 as typically built into the frame of a bicycle 22. It also shows a customary cylindrical Cycling Bottle 5 and the position thereon of the customary diameter narrowing herein called the Neck 7. It also shows a customary Bottle Retention Hook 6, occupying the void of the Neck area 7, thus aiding in holding the Cycling Bottle 5 in position.

FIGS. 3A, 3B and 3C show an example of how the Apparatus 1, made up of an Enclosure 4 and Wings 8, is fitted to be attached to a bicycle 22 by Mounting Bracket 2 and two Bottle Cage Screws 28 fitted to attach to bicycle 22 via the standardized Bottle Cage Bosses 3. FIG. 3A shows the movement of attachment, FIG. 3B shows the apparatus once attached, and FIG. 3C show a cross section of the apparatus once attached to bicycle 22. Bicycle 22 and Bottle Cage Bosses 3 are not part of the present invention. Also shown is the Bottle Retention Hook 6, and the lock latch 34 when the lock is in the locked position.

FIGS. 4A, 4B, 5A and 5B show an example of a sequence for removing the Wings 8 from the Enclosure 4. FIG. 4A shows the apparatus with wings in place, FIG. 4B shows step 1 of wing removal: tilting the wings 8 forward. FIG. 5A shows step 2: sliding the wings 8 forward. FIG. 5B shows step 3: raising the wings up and off.

FIG. 6A is a diagram showing an exemplary organization of electronic components within the Enclosure 4. Cross section FIGS. 6B and 6C show an exemplary method of using a lock 30 with a latch 34, incorporated into the Enclosure 4. In FIG. 6B the lock latch 34 is in position to secure the Enclosure 4 in place. In FIG. 6C the lock latch 34 is in open position, allowing the Enclosure 4 to slide off the Mounting Bracket 2.

FIG. 7 shows an exemplary block diagram of the electronic components on the Printed Circuit Board Assembly (PCBA) 29 within the Enclosure 4.

FIG. 8 shows an exemplary data communication system connecting the Apparatus with a user's phone.

FIG. 9 shows an exemplary boot sequence.

FIG. 10 shows an example of logic by which the user can control he activity of the Apparatus.

Numbering of items in the figures is consistent across all the figures, and numbered items are listed here for reference: Apparatus 1, Mounting Bracket 2, Bottle Cage Boss 3, Enclosure 4, Bottle or Cycling Bottle 5, Bottle Retention Hook 6, Neck 7, Wings 8, Microprocessor 9, Memory 10, battery 11, wireless radio 12, cellular antenna 13, GPS receiver 14, GPS antenna 15, motion sensor 16, charging port 17, cellular IoT network 18, cloud-based service 19, mobile phone 20, Bottle Cage 21, bicycle 22, system clock 23, internal timer expired 25, motion detected 26, app on mobile phone 27, Cage Screws 28, PCBA 29, Bottle Lock 30, Key 31, Waterproof interior of Enclosure 32, Backstop 33, Lock Latch 34.

### DESCRIPTION OF THE PRESENT INVENTION

The components described in the Background section above, and the terms defined therein, are common and customary in the cycling community. These generic features are not claimed as elements of the present invention. However, the present invention does claim unique manners of accomplishing the functions of a customary Bottle Cage, and compatibility with a customary Cycling Bottle.

The present invention combines the functions of a bicycle Bottle Cage, with the functions of an anti-theft device. One element of the invention is an Apparatus consisting of an Enclosure, Wings, a separate Mounting Bracket, and various electronic components as described herein. Said Apparatus is attached to a bicycle in a manner such that its bottle-holding components and features accept a Cycling Bottle, holding it securely in place while allowing a rider to pull out the Bottle for a drink in the customary manner.

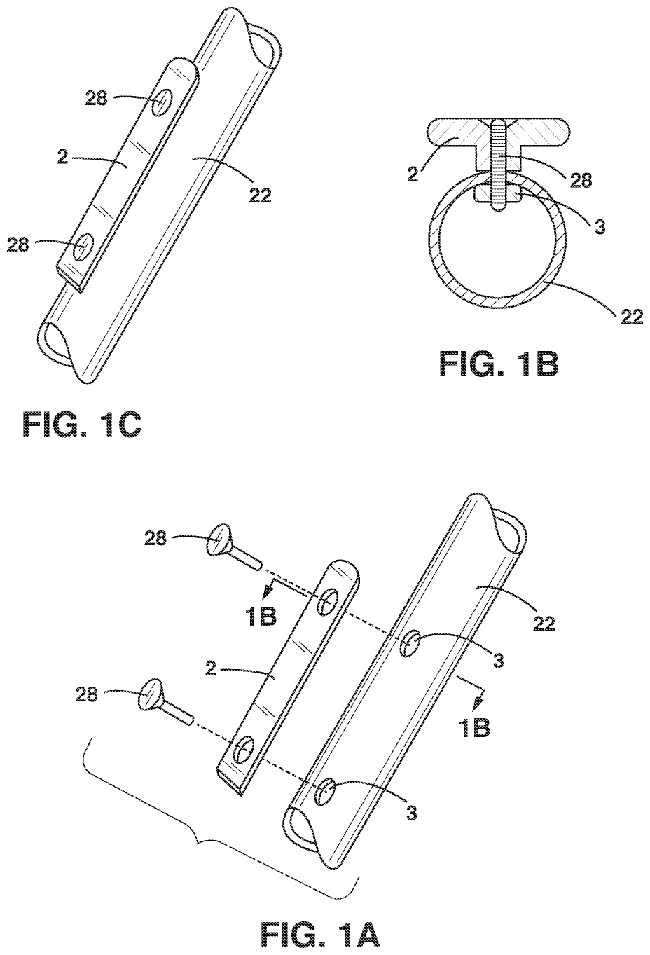

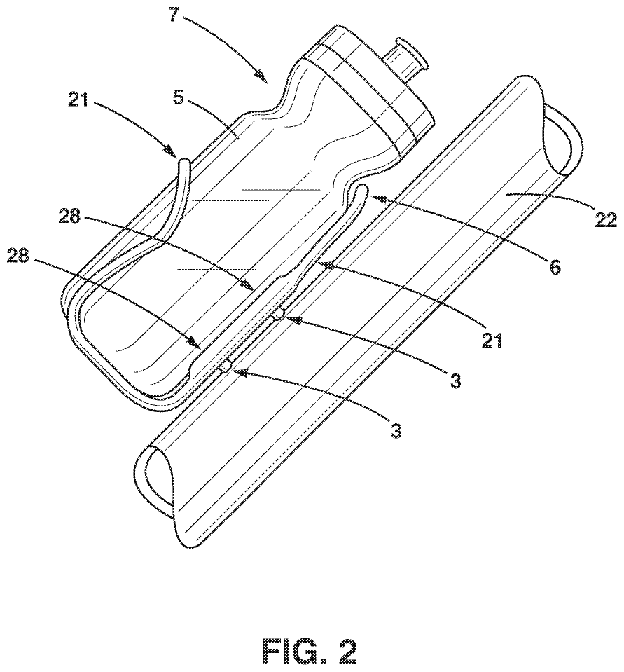

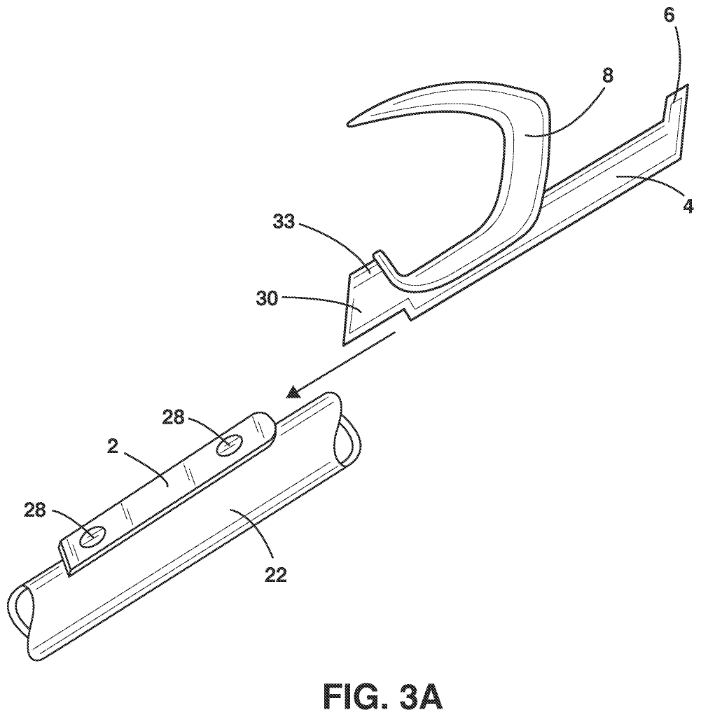

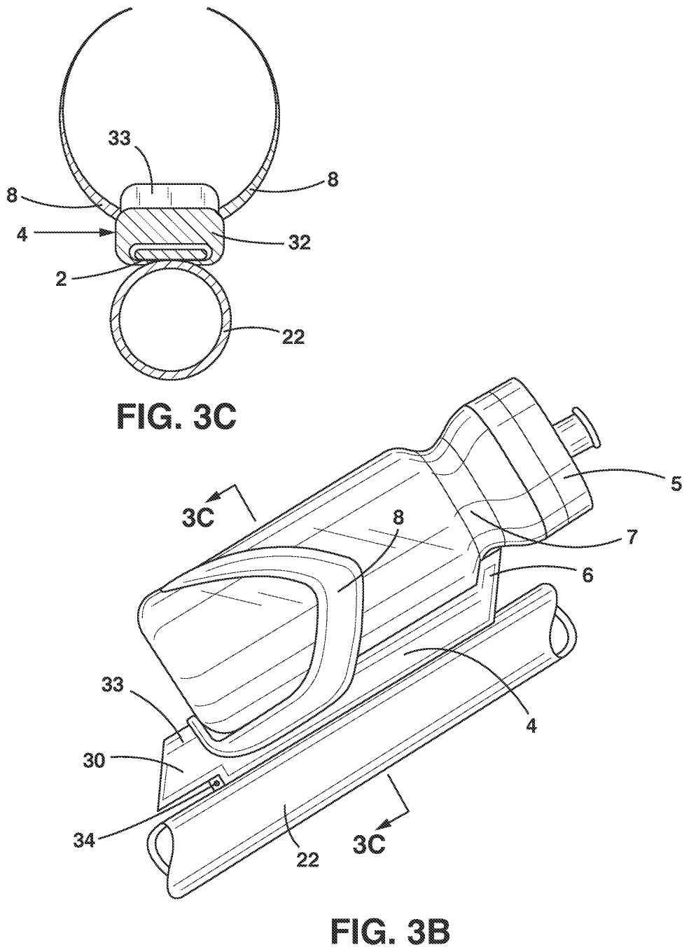

In one exemplary embodiment shown in FIG. 1A, a Mounting Bracket 2 is fitted to make use of two standardized Bottle Cage Bosses 3 customarily built into the frames of bicycles. The Mounting Bracket 2 provides for the attachment of an Enclosure 4 to the bicycle 5 in a similar location and manner as a customary Bottle Cage, thus providing a convenient location for the rider's Bottle in keeping with custom. In this embodiment, the Mounting Bracket, once attached to the bicycle using tools, can remain installed on the bicycle, while the Enclosure can be removed from said Mounting Bracket, and taken elsewhere for charging or to be placed on a different bicycle, without the use of tools. FIG. 3A shows how, in this embodiment, the Enclosure 4 can be attached to the Mounting Bracket 2 by sliding it into place. FIGS. 3B and 3C show the Enclosure 4 after it has been moved into position on the Mounting Bracket 2. Further, in this embodiment, the Enclosure can be removed from the Mounting Bracket 2 by the reverse of the action shown in FIG. 3A.

As shown in FIG. 3A, 3B, and 3C, the Enclosure 4 in combination with Wings 8 creates a shape that lends itself to holding a cylindrical Cycling Bottle 5. FIG. 3B shows that the Enclosure 4 also features a bottle backstop 33 and a Bottle Retention Hook 6 at the proper location to fit into the void created by the Neck 7 of the Bottle 5, to help hold the Bottle 5 in place. Cycling Bottle 5 with Neck 7 is not a part of the present invention. Rather, the invention is fitted to conform to customary shapes of these items.

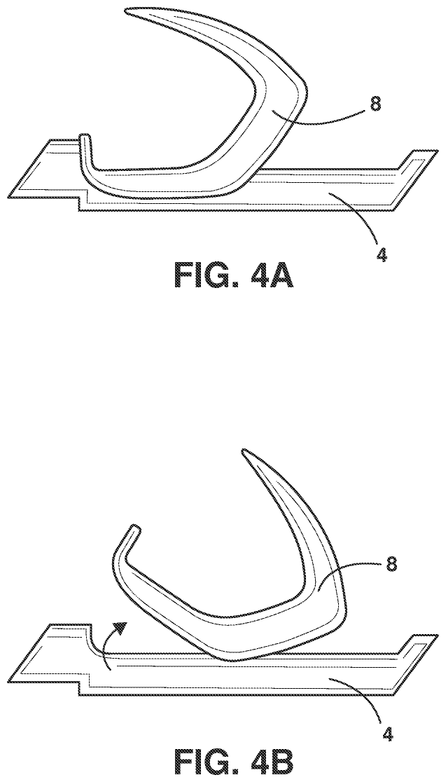

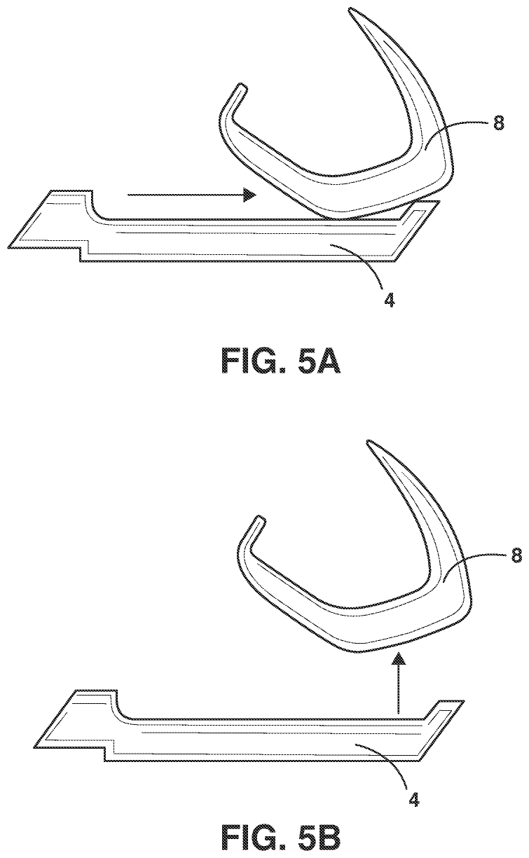

A traditional Bottle Cage features elements that reach around and over the top of the Bottle, further holding it in position. As shown in FIGS. 3B and 3C the present invention is designed to act in a similar way, with elements herein called “Wings” 8 reaching around the Bottle 5. The Wings 8 are flexible and thus allow the rider to insert or remove the Bottle 5 with relative ease. In one exemplary embodiment (not shown), the Wings are designed to be integrated into the Enclosure of the Apparatus. In another exemplary embodiment, shown in FIGS. 4A, 4B, 5A, and 5B, the Wings 8 are designed such that they can be attached to the Enclosure 4, or removed from it, without the use of tools.

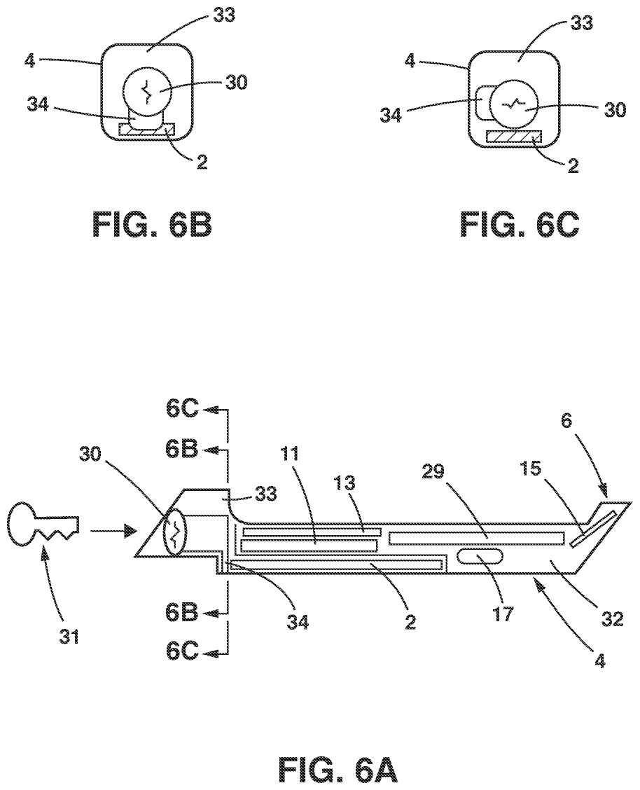

As shown in FIG. 6A, inside the Enclosure 4 of the Apparatus are several components designed to provide anti-theft functions. This includes but is not limited to: a printed circuit board assembly (PCBA) 29, a battery 11, a cellular antenna 13, a GPS antenna 15, and a means of charging the battery which in this example is a charging port 17. The Apparatus is positioned such that the cellular antenna 13 is able to send and/or receive radio frequencies, and the GPS antenna 15 is able to receive radio frequencies, not blocked by the frame or other elements of the bicycle.

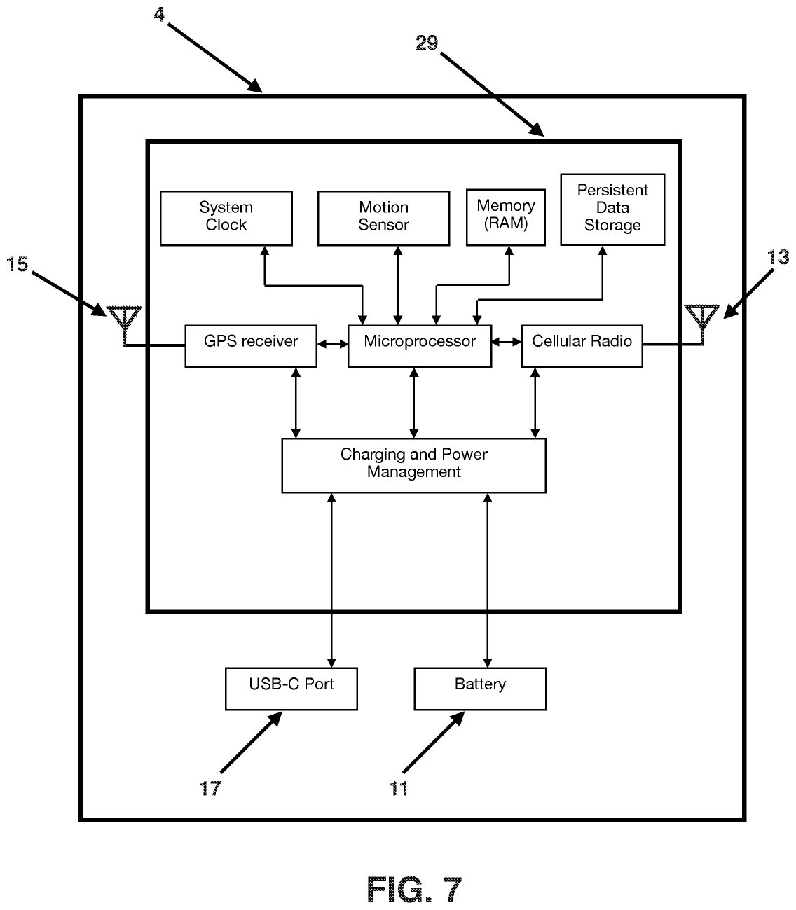

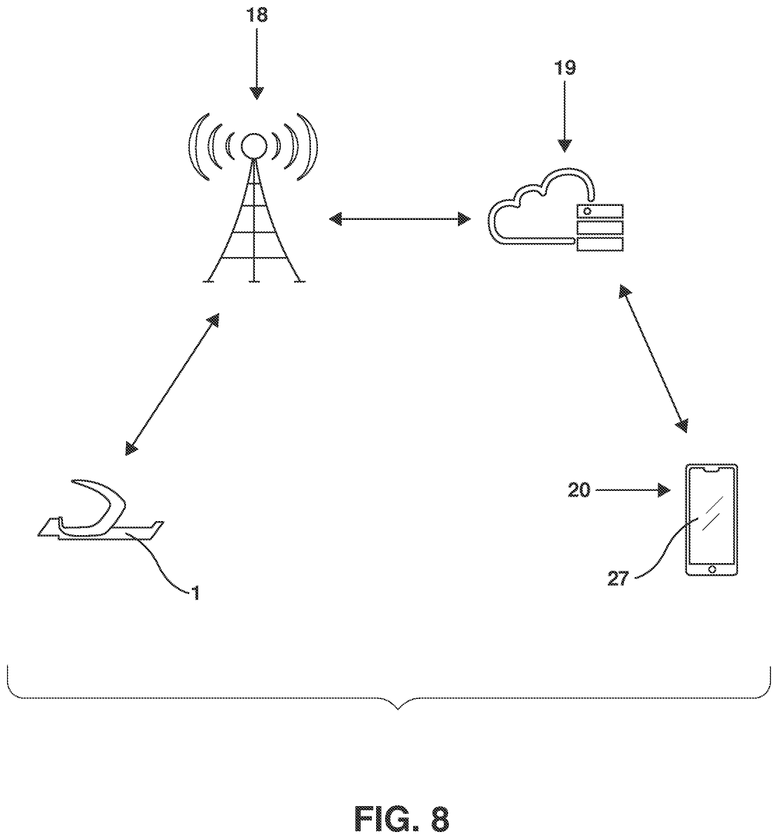

FIG. 7 is a block diagram showing an exemplary implementation of the PCBA 29 within the Enclosure 4, and associated other parts. This exemplary version of a bicycle anti-theft device includes, but is not limited to, elements as enumerated in said block diagram, to wit, a Microprocessor, Memory (RAM), persistent data storage, a cellular radio, a GPS receiver, a motion sensor, a system clock, and a charging and power management unit. Further, the block diagram shown in FIG. 7 describes ancillary components attached to the PCBA components. These include, in this example, a GPS antenna 15, a cellular antenna 13, a battery 11, and a means of charging said battery, which in this example is a USB Type C port 17.

In the system herein described the Apparatus is one component of a system of data communication, storage and presentation to a user whereby the user can be informed if the bicycle is being unexpectedly moved, such as when a thief might be working to break a bicycle lock using tools such as a bolt cutter, a grinder, or a hacksaw, or if the bicycle is being moved to a different location, such as when a thief might have succeeded at breaking said bicycle lock, and is riding away on the bicycle.

In one exemplary embodiment, shown in FIG. 8, the data communication system features a data link between the Apparatus 1 and a cellular IoT network 18, then a link between said cellular network and a cloud-based service 19, and finally a link between said cloud-based service and a user's mobile phone 20. In this embodiment, data and alerts can travel from the Apparatus 1 to the user's mobile phone 20 or to an app 27 on said mobile phone. Conversely, commands can travel from an app 27 on the user's mobile phone to the Apparatus 1 via the reverse path.

In another exemplary embodiment (not shown), the data communication system features a data link between the Apparatus 1 and a cellular network, then a direct link a user's mobile phone. In this embodiment, a communications method such as for example SMS (Simple Messaging Service) can be used to communicate data and alerts to the user's mobile phone, or to communicate commands directly to the Apparatus 1.

In another exemplary embodiment (not shown), the data communication system features a data link between the Apparatus and a mobile phone, making use of a local WiFi network, or making use of a Bluetooth or similar small area network.

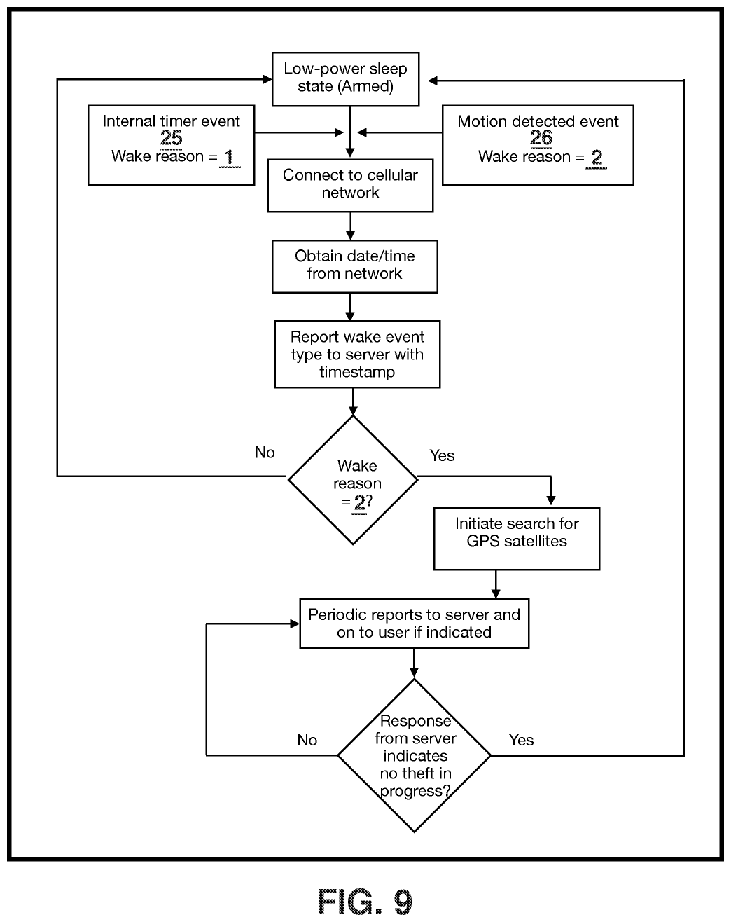

In one exemplary embodiment of the system of the present invention, the apparatus is capable of autonomous monitoring activity. This includes the ability to boot up based on several possible inputs, and to begin to function as an anti-theft device capable of reporting motion (e.g. jostling), and changes in location. FIG. 9 shows an exemplary logic flow diagram of a boot sequence triggered by the detection of motion 26, or being awakened by an internal timer 25.

FIG. 9 logic illustrates an autonomous boot-up sequence which establishes a radio connection to a data communication network. It then obtains the current date and time from the network and initializes its internal system clock with said current date and time. It then reports the reason for its wake-up, timestamped by the system clock, via the radio connection to a cloud-based server. If the wake-up reason is that motion is detected, this may constitute a notification to the user of a possible theft.

FIG. 9 also shows that if the reason for wake-up was motion, the Apparatus commences a search for GPS satellites (as shown) or for other location sources such as for example WiFi (not shown), and thereby attempts to get a location fix. On obtaining a location fix, the Apparatus begins to transmit location data, timestamped by the system clock, via the previously established radio communications network to said cloud-based server. This can then generate a notification or a series of notifications to the user (not shown), and can continue reporting the location of the Apparatus, and by extension the user's bicycle, in real time. This constitutes essential information for the tracking down and recovery of the bicycle and perhaps the apprehension of the thief.

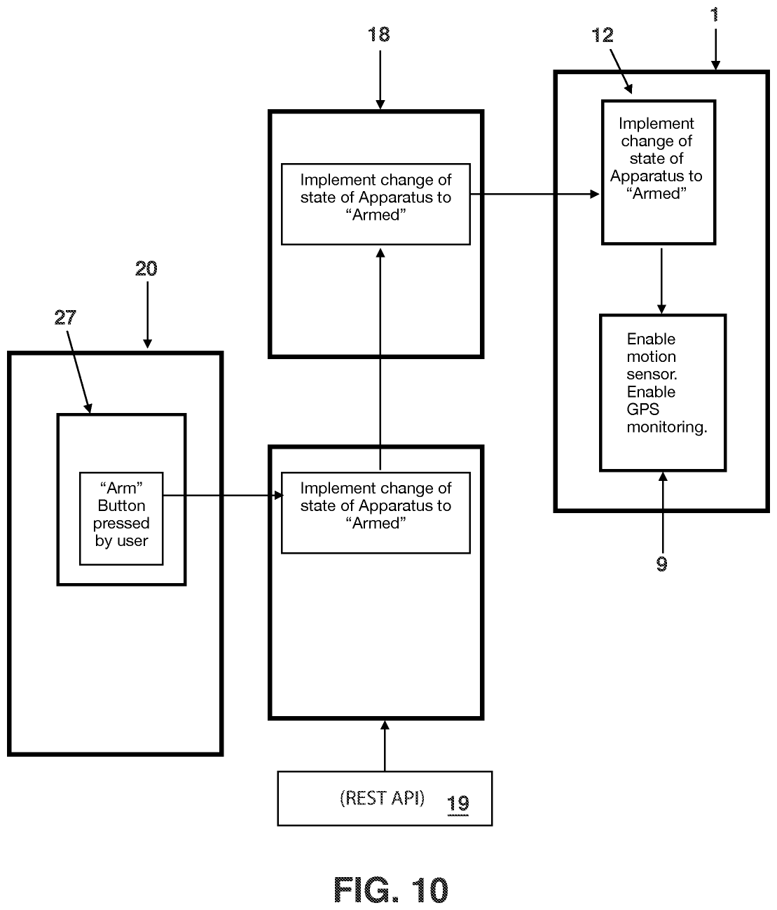

In one exemplary embodiment, a component of the system is an app on a mobile phone of the user. FIG. 10 shows the logic by which a user can direct the Apparatus to start or stop specific activities, in the example shown, arming itself to report events that may indicate a theft. A variety of control actions may be provided to the user by similar logic. Examples of commands that may be useful include “start tracking waypoints of a ride,” or “enter Airplane Mode.”

In other exemplary embodiments, the function of allowing user control of the system provided by the mobile phone in FIG. 10 may be provided by other means of user input, including but not limited to a computer, a website, a smart watch, etc.

Many cyclists are sensitive to the total weight of their bicycle and attached components. By combining the functions of a Bottle Cage with that of an anti-theft device, the overall weight is kept to a minimum. In doing so, the present invention meets the usefulness requirement.

A bicycle anti-theft apparatus becomes much less useful if a thief removes it from the bicycle, because it can no longer report location data. Such an apparatus can thus be more effective if it is not detected. A Bottle Cage being commonly found on bicycles, a thief may overlook an anti-theft device that is “disguised” as a Bottle Cage, as in the present invention. By hiding in plain sight, the present invention meets the novelty, usefulness, and non-obvious requirements.

Employing an alternative strategy, the Apparatus can be clearly branded with a name indicating an anti-theft purpose (e.g. MaxTracker) combined with marketing the features that focus on immediate notification and/or alarm on any disturbance or movement of the bike. A thief may become aware of the product's existence in the marketplace and its ability to quickly alert the owner of a possible theft. The thief may thus be deterred from stealing that particular bike, choosing a different target instead. Users who prefer not to engage in confrontation with a thief are well served by this strategy of deterrence. By being in plain site, but not hiding in this case, the present invention meets the usefulness requirements.

1. An Apparatus consisting of
a) a Mounting Bracket fitted to be attached to a Bicycle by means of screws fitted to be screwed into standard bicycle bottle cage attachment bosses, which bosses are fully specified in the bicycle industry and are a standardized feature of many bicycles
b) an Enclosure housing a microprocessor, memory, persistent storage, a battery, a means of wireless communication, a means of geo-location, a motion sensor, and a system clock
c) a bottle-gripping structure incorporated with said Enclosure and fitted to hold in place a customary cycling bottle
d) said Mounting Bracket and said Enclosure designed to be fitted together in a manner that creates a mechanism allowing said Enclosure to be attached to or detached from said Mounting Bracket, and thereby attached to or detached from said Bicycle, said mechanism also incorporating a locking element capable of locking said Enclosure in place such that a lock-management method is required to detach said Enclosure from said Mounting Bracket.

2. The Apparatus of claim 1 wherein said lock-management method is a key.

3. The Apparatus of claim 1 wherein said lock-management method is a fingerprint reader.

4. The Apparatus of claim 1 wherein said lock-management method is a numeric keypad.

5. The Apparatus of claim 1 wherein said means of wireless communication is a cellular radio which connects to the cellular network.

6. The Apparatus of claim 1 wherein said means of wireless communication is a Wi-Fi radio which connects to Wi-Fi access points.

7. The Apparatus of claim 1 wherein said means of wireless communication is a Bluetooth radio which connects to other Bluetooth communicators.

8. The Apparatus of claim 1 wherein said bottle gripping structure is incorporated with said Enclosure by being integrated into the shape of said Enclosure.

9. The Apparatus of claim 1 wherein said bottle gripping structure is incorporated with said Enclosure by being designed to be attached to and detached from said enclosure without requiring the use of tools.

10. The Apparatus of claim 1 wherein said bottle gripping structure is constructed of a flexible plastic or polymer.

11. The Apparatus of claim 1 wherein said means of geo-location is a GPS receiver and a GPS antenna.

12. The Apparatus of claim 1 wherein said means of geo-location is by use of Wi-Fi location service.

13. The Apparatus of claim 1 wherein said means of geo-location is Positioning over LTE (PoLTE).

14. A system consisting of an Apparatus attached to a bicycle configured to hold a Cycling Bottle, and consisting of an Enclosure housing a Microprocessor, Memory, a battery, a means of wireless communication, a means of geo-location, a motion sensor, a wireless communications antenna, a GPS antenna, and in communication with data communication equipment capable of conveying bicycle status information to a user.

15. The system of claim 14 in which said bicycle status information is related to the motion of said bicycle.

16. The system of claim 14 in which said bicycle status information is related to the location of said bicycle.

17. The system of claim 14 in which said means of wireless communication is via the cellular network.

18. The system of claim 14 in which said means of wireless communication is via WiFi.

19. The system of claim 14 in which said means of wireless communication is via BlueTooth.

20. The system of claim 14 in which said means of wireless communication is via any wireless communications protocol.

21. The system of claim 14 in which the information is conveyed to said user via the user's mobile phone.

22. The system of claim 14 in which the information is conveyed to said user via a website or web portal.

23. The system of claim 21 in which the information conveyed via said mobile phone is conveyed via a mobile phone app.

24. The system of claim 21 in which the information conveyed via said mobile phone is conveyed via a text message.

25. The system of claim 14 in which said bicycle status information is conveyed via an email.
